(19) United States
(12) Patent Application Publication
(10) Pub. No.: US 2020/0286379 A1
(43) Pub. Date: Sep. 10, 2020

(54) MOBILE OBJECT AND SERVER APPARATUS

(71) Applicant: TOYOTA JIDOSHA KABUSHIKI KAISHA, Toyota-shi (JP)

(72) Inventors: Masato ENDO, Tokyo (JP); Katsuhiko YOUROU, Toyota-shi (JP); Shunji TATEISHI, Kasugai-shi (JP); Nobukatsu FUJISHITA, Nagoya-shi (JP)

(73) Assignee: TOYOTA JIDOSHA KABUSHIKI KAISHA, Toyota-shi (JP)

(21) Appl. No.: 16/799,009

(22) Filed: Feb. 24, 2020

(30) Foreign Application Priority Data
Mar. 5, 2019 (JP) 2019-039613

(51) Int. Cl. G08G 1/0968; H04W 4/021; H04W 4/42; G06Q 50/30

(52) U.S. Cl. CPC G08G 1/096838; G08G 1/096883; G06Q 50/30; H04W 4/021; H04W 4/42; G08G 1/096866

(57) ABSTRACT

A mobile object for moving within a facility includes: a candidate location information acquisition device configured to acquire candidate location information regarding locations of a plurality of destination candidates in the facility; a current location information acquisition device configured to acquire current location information on the mobile object; an other mobile object information acquisition device configured to acquire other mobile object location information regarding locations of a plurality of other mobile objects that move within the facility; and a route acquisition device configured to acquire a route for moving to at least one destination candidate out of the destination candidates, based on the candidate location information, the current location information, and the other mobile object location information.

### INCORPORATION BY REFERENCE

The disclosure of Japanese Patent Application No. 2019-039613 filed on Mar. 5, 2019 including the specification, drawings and abstract is incorporated herein by reference in its entirety.

### BACKGROUND

### 1. Technical Field

The present disclosure relates to a mobile object and a server apparatus.

### 2. Description of Related Art

In recent years, systems and methods have been proposed for easing congestion in outdoor facilities that attract many people, such as amusement parks and zoos.

Japanese Patent Application Publication No. 2016-42275 (JP 2016-42275 A) discloses a method for easing congestion in areas around concert halls, stadiums, or the like, where many people gather. Specifically, the disclosed method is for determining an attraction that attracts a sufficient number of people for easing congestion, based on correlativity between congestion situations and attractions that may attract a gathering of people.

Japanese Patent Application Publication No. 2015-524117 (JP 2015-524117 A) discloses a method for reducing waiting time in a plurality of attractions (for example, mobile objects, restaurants, shops, and entertainments) provided in amusement parks. Specifically, the disclosed method is for allowing visitors to enter a virtual queue for an attraction using a wireless technology.

### SUMMARY

However, the technique disclose in JP 2016-42275 A is simply for easing the congestion on a route that connects two specific points, such as a route from an event site to a near railway station after the end of an event. Accordingly, it is hard to apply the technique to easing the congestion in huge outdoor facilities, such as amusement parks and zoos, which provide a large number of attractions and highlights, and therefore embrace many unspecified routes.

The technique disclosed in Japanese Patent Application Publication No. 2015-524117 (JP 2015-524117 A) only allows visitors to make a reservation for an attraction to eliminate the necessity of the visitors waiting in front of the attraction until the reservation time comes. Accordingly, the technique does not provide a method for allowing visitors to comfortably move between the attractions provided in vast outdoor facilities.

The present disclosure provides a mobile object and a server apparatus allowing comfortable movement between a plurality of points provided in a facility.

The present disclosure relates to a mobile object for moving within a facility. The mobile object includes a candidate location information acquisition device, a current location information acquisition device, an other mobile object information acquisition device, and a route acquisition device. The candidate location information acquisition device is configured to acquire candidate location information regarding locations of a plurality of destination candidates in the facility. The current location information acquisition device is configured to acquire current location information on the mobile object. The other mobile object information acquisition device is configured to acquire other mobile object location information regarding locations of a plurality of other mobile objects that move within the facility. The route acquisition device is configured to acquire a route for moving to at least one destination candidate out of the destination candidates, based on the candidate location information, the current location information, and the other mobile object location information. The information on the location of the destination candidate may be location information on a standby place in the vicinity of the destination where the mobile object can wait or may be information indicating a prescribed region.

The mobile object may further include a display device configured to display the route acquired by the route acquisition device to a user of the mobile object. The mobile object may calculate and acquire the route by itself or may receive from a server apparatus or the like.

The route acquisition device may be configured to select at least two destination candidates out of a plurality of destination candidates, based on candidate location information, current location information, and other mobile object location information, and acquire a route for moving from the current location to the first destination candidate selected by a destination selection device and then moving from the first destination candidate to the second destination candidate. The mobile object may include a display device configured to display the route to a user of the mobile object. It is also possible to calculate a route connecting the current location and the at least two destination candidates acquired by the route acquisition device, the route being different from a shortest route.

The present disclosure relates to a mobile object for moving within a facility. The mobile object includes an input unit, a candidate location information acquisition device, a current location information acquisition device, an other mobile object information acquisition device, and a route acquisition device. The input unit is configured to receive inputs of at least two destination candidates, out of a plurality of destination candidates in the facility, from a user of the mobile object. The candidate location information acquisition device is configured to acquire candidate location information regarding locations of the destination candidates input via the input unit. The current location information acquisition device is configured to acquire current location information on the mobile object. The other mobile object information acquisition device is configured to acquire other mobile object location information regarding locations of other mobile objects that moves within the facility. The route acquisition device is configured to acquire a route for sequentially moving from the current location to at least two destination candidates, selected out of the destination candidates input via the input unit, based on the candidate location information, the current location information, and the other mobile object location information.

The other mobile object location information may include information indicating the number of the other mobile objects scheduled to be present in each of the at least two destination candidates in each of a plurality of time periods.

The present disclosure relates to a server apparatus used for a moving system using a plurality of mobile objects that move within a facility. The server apparatus includes a current location information acquisition device, a schedule information acquisition device, and an output device. The current location information acquisition device is configured to acquire current location information from each of the mobile objects. The schedule information acquisition device is configured to acquire, from each of the mobile objects, information indicating a schedule to be present in a prescribed destination candidate in a prescribed time period. The output device is configured to output, to one of the mobile object, information indicating the number of the other mobile objects scheduled to be present in the prescribed destination candidate in the prescribed time period. The information indicating the schedule to be present in a destination candidate may be information indicating the schedule to be present in a prescribed region around the destination candidate, the prescribed region including a standby place of the mobile object.

### BRIEF DESCRIPTION OF THE DRAWINGS

Features, advantages, and technical and industrial significance of exemplary embodiments of the disclosure will be described below with reference to the accompanying drawings, in which like numerals denote like elements, and wherein:

FIG. 1 shows a schematic configuration of a mobile object 100 according to an embodiment;

FIG. 2 is a block diagram of the mobile object 100 according to the embodiment;

FIG. 3 shows a schematic configuration of a moving system 220 according to the embodiment;

FIG. 4 is a schematic view showing an example of an outdoor facility 300;

FIG. 5 is a flowchart illustrating a method of using the mobile object 100;

FIG. 6 shows location information on other mobile objects 100 acquired by a server apparatus 200;

FIG. 7 is a flowchart showing destination setting procedures; and

FIG. 8 shows a schematic configuration of an inverted mobile object 1 according to a modification.

### DETAILED DESCRIPTION OF EMBODIMENTS

Hereinbelow, an embodiment of the present disclosure will be described in detail with reference to the drawings. The following embodiment is only illustrative for explanation of the present disclosure and is not intended to limit the present disclosure to the embodiment. The component members which exhibit identical or similar functions are designated by identical or similar reference numerals to omit redundant description.

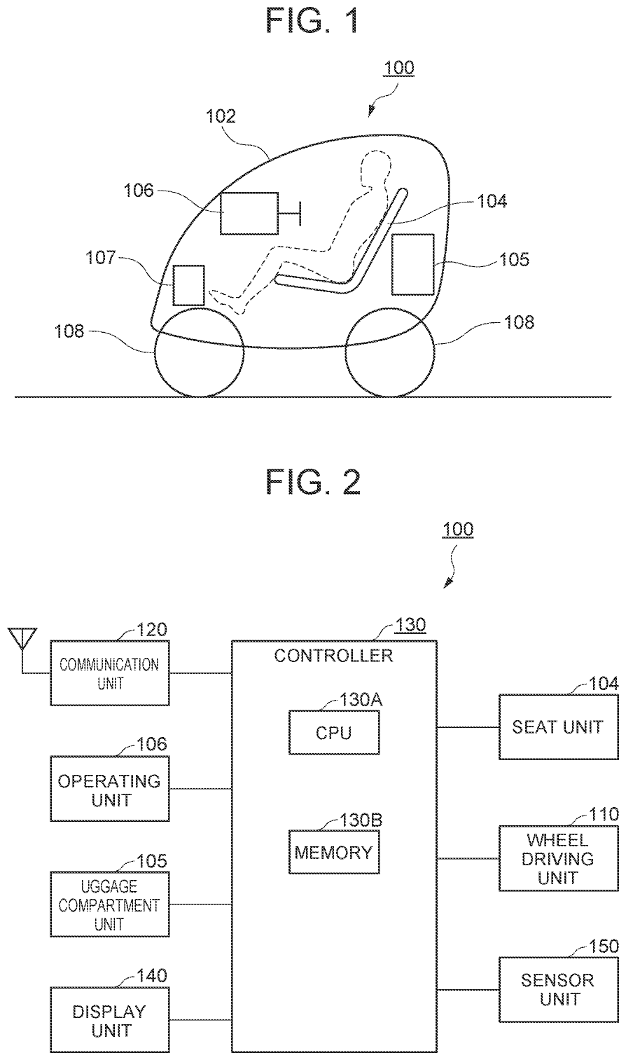

FIG. 1 shows a schematic configuration of a small mobile object 100 according to the embodiment. For example, the mobile object 100 is used in an outdoor facility, such as amusement parks, zoos, or event sites, by guests, such as visitors of the outdoor facility. The same mobile object 100 is sequentially used by a large number of users who visit the outdoor facility.

The mobile object 100 includes a vehicle body 102. The vehicle body 102 is equipped with a seat unit 104 including a seat on which a driver sits, and a seat on which other passenger or passengers (hereinafter the driver and other passengers of the mobile object 100 are generically called “users”) sit. The seats of the vehicle body 102 are covered with a roof unit for protecting the users against sun and rain. The seat unit 104 may be provided with a seat reclining device for tilting the seat, and a roof opening and closing mechanism for housing the roof unit in the vehicle body 102. Provided behind the seat is a luggage compartment unit 105 including a luggage compartment for storing luggage of the users. The vehicle body 102 is further provided with an air conditioning unit 107 capable of supplying cold air and warm air to the users. The mobile object 100 is further provided with an operating unit 106 for operating each unit of the mobile object 100. The vehicle body 102 is further equipped with wheels 108 for moving. For example, the mobile object 100 according to the present embodiment is a four-seat compact vehicle having, four example, two front wheels 108 and one rear wheel 108. The mobile object 100 can be moved by driving by a driver. The mobile object 100 is also configured to be switched to an autonomous driving mode which allows autonomous travel. The mobile object 100 further includes a display unit 140 for displaying a facility map and a scheduled moving route of the mobile object 100.

FIG. 2 is a block diagram showing a schematic system configuration of the mobile object 100 according to the embodiment. The mobile object 100 according to the present embodiment includes a wheel driving unit 110 which drives each of the wheels 108, the seat unit 104 for controlling the seats, or the like, on which the users sit, and the operating unit 106 for the driver to operate the mobile object 100. The mobile object 100 also includes the luggage compartment unit 105 for storing the luggage of the users, a communication unit 120 for enabling communication with external apparatuses, a controller 130 for controlling the mobile object 100 based on a driving operation by the driver, a sensor unit 150 including various sensors and outputting the information acquired from these sensors to the controller 130, the display unit 140 for displaying various notifications to the users, and the air conditioning unit 107.

The wheel driving unit 110 includes actuators for devices such as an electric motor and a brake incorporated in the vehicle body 102. The actuators for the devices such as the wheels 108, and the brake can be driven in accordance with control signals generated by the controller 130, based on operation of a steering wheel, or the like, by the driver through the operating unit 106, or on sensor signals from the sensor unit 150.

The seat unit 104 can drive the reclining device of the seat, the roof opening and closing mechanism, or the like, based on control signals received from the controller 130. The luggage compartment unit 105 includes the luggage compartment for storing the luggage of the users, and a door attached to the luggage compartment. The door of the luggage compartment can be locked or unlocked based on a control signal received from the controller 130.

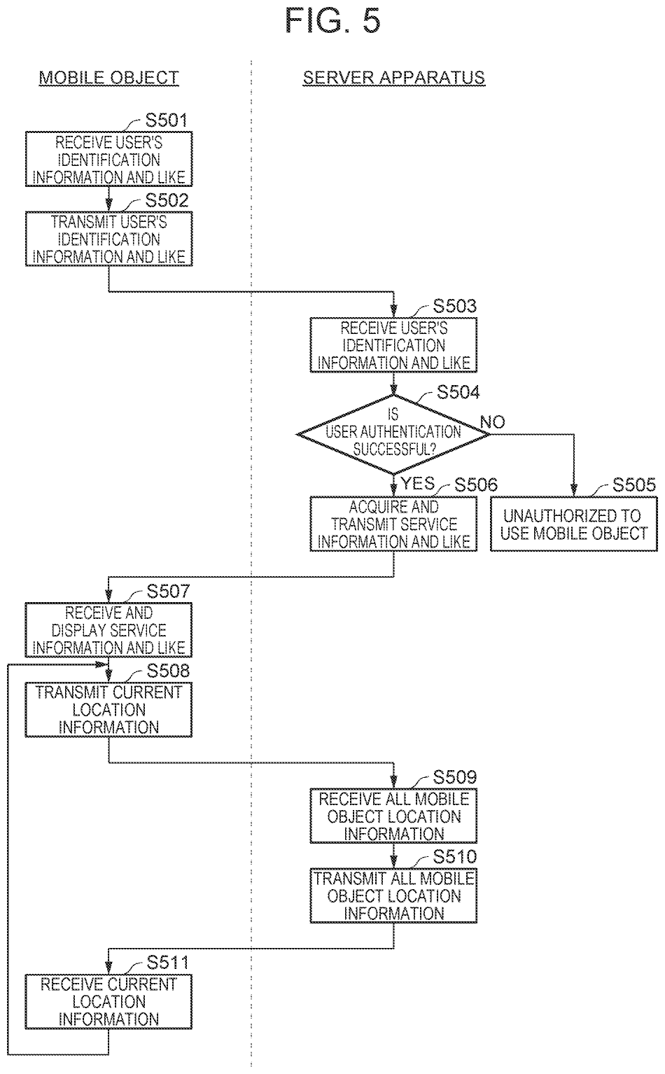

The controller 130 (electronic control unit) includes a CPU 130A and a memory 130B. The controller 130 generates control signals for driving the actuators for each of the units of the mobile object 100, and outputs the control signals to each of the units. The CPU 130A includes one or more processors. The CPU 130A executes various arithmetic processes included in the present disclosure, in response to commands included in various computer programs, such as firmware, stored in a nonvolatile semiconductor memory, such as a NAND flash memory included in the memory 130B, to control each of the units. The memory 130B stores computer programs for executing various arithmetic processes (including various arithmetic processes shown in the flowchart, or the like, of FIG. 5 or the like) included in the present disclosure, computer programs for performing arithmetic processes for controlling the wheel driving unit 110 based on the operating unit 106, and computer programs for executing arithmetic processes for autonomously controlling the wheel driving unit 110 based on information on the sensor signals, or the like, acquired from the communication unit 120 and the sensor unit 150 during autonomous driving. The nonvolatile semiconductor memory in the memory 130B further stores map data on the outdoor facility. The memory 130B further includes a cache memory formed of a SRAM, a DRAM, or the like, which temporarily stores data on arithmetic processes performed by the CPU 130A, and a congestion situation of the day.

The operating unit 106 includes a steering wheel for the driver to control the moving direction of the mobile object 100. The operating unit 106 also includes an accelerator pedal and a brake pedal for operating the electric motor and the brake mounted on the wheel driving unit 110. The operating unit 106 further includes switches for the users to drive the seat reclining device, the roof opening and closing mechanism, and the air conditioning unit 107. As the operating unit 106, a touch panel operable by the driver, or a microphone which recognizes the voice of the driver and a voice recognition processing software supporting a plurality of languages may be mounted on the mobile object 100, and the mobile object 100 may be configured to be operable based on pressing operation on the touch panel by the driver or based on the speech of the driver.

The sensor unit 150 includes various sensors for measuring environment values, or the like, around the mobile object 100. The sensor unit 150 outputs respective pieces of information necessary for the controller 130 to control the mobile object 100 to the controller 130. The sensors may include a plurality of cameras for imaging front and rear images of the mobile object 100, a LiDAR ranging system including a millimeter-wave radar for avoiding collision with pedestrians, or the like, and an infrared camera. The sensor unit 150 may include a semiconductor IC for image processing which enables image recognition, or the like. The sensor unit 150 may be configured to recognize traffic signs disposed in the facility and obstacles, such as pedestrians, based on the images imaged with the cameras or the like, and may output the recognized objects to the controller 130. The sensor unit 150 may further estimate the current location from images of markers for location detection disposed on the road surface in the facility, surrounding images, or the like, and may output the location information to the controller 130. The sensor unit 150 may further include a magnetic sensor for detecting magnetic markers embedded under the surface of the road along which the mobile object 100 moves, and may output the location information and other information (for example, information indicating a stop position, and information indicating a no-entry place) to the controller 130. For example, the controller 130 may output control signals for controlling the wheel driving unit 110 such that the mobile object 100 stops at a stop position, irrespective of the operation by the driver, based on the sensor signal received from the sensor unit 150 so to prevent the mobile object 100 from advancing to the no-entry place. As a result, the mobile object 100 may be configured to travel only within the region where travel is permitted. The sensor unit 150 further includes a rotary encoder, or the like, for detecting the speed of the wheels 108, and outputs speed information to the controller 130. The mobile object 100 may be configured such that the controller 130 outputs control signals for controlling the accelerator and the brake, irrespective of the operation by the driver, so as not to exceed a prescribed speed.

The communication unit 120 includes communication devices, such as an antenna and a mobile application processor for exchanging information with an external apparatus, such as the server apparatus 200. For example, the communication unit 120 includes communication devices in conformity with a plurality of telecommunication standards, such as near field communication (NFC) (near field communication system instituted in the NFC forum), and WiFi (wireless communication system based on 802.11 standards instituted by the IEEE), for exchanging information with personal digital assistants possessed by the users. The communication unit 120 may further include a recognition device of images or the like, such as a bar-code reader for reading a two-dimensional barcode, or the like, which is displayed on admission tickets possessed by the users for admission to the facility. The communication unit 120 further include a communication device, such as a GPS or the like, for acquiring location information and outputting to the controller 130. The display unit 140 includes a display device, such as a liquid crystal display for displaying notification to the users. The air conditioning unit 107 operates based on operation on a switch of the operating unit 106 by the users. The air conditioning unit 107 includes an air conditioner for blowing cool air or warm air to the feet of the users.

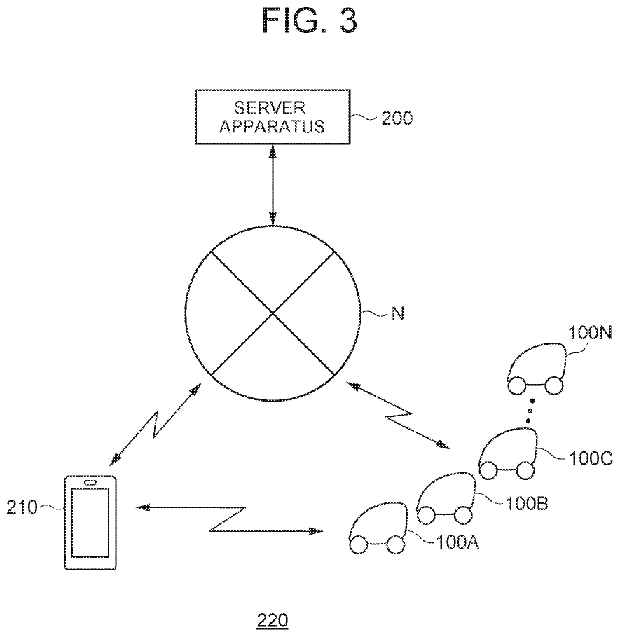

FIG. 3 shows a schematic configuration of the moving system 220 according to the embodiment. The moving system 220 includes the mobile objects 100, and the server apparatus 200 that can exchange information with each of the mobile objects 100 through a network N. Hereinafter, when specific mobile objects 100 are referred, they are designated as, for example, a mobile object 100A, a mobile object 100B, or the like. When the mobile objects 100 are generically referred, they are simply designated as the mobile objects 100. The network N may at least partially include the public Internet or may be a dedicated local area network (LAN). The server apparatus 200 may be provided in a place other than the outdoor facility where the mobile objects 100 move.

The server apparatus 200 can transmit and receive information through the personal digital assistants 210 possessed by the users of the moving system 220 and the network N. The personal digital assistants 210 have application software installed so as to use the moving system 220. When starting up the application software, the user can execute each arithmetic process with the personal digital assistant 210 shown in the present disclosure.

The mobile objects 100 can further exchange information through the network N or directly with the personal digital assistants 210. For example, the mobile objects 100 may be configured to directly communicate with the personal digital assistants 210 in an ad-hoc mode defined by the 802.11 standard, without through the network N.

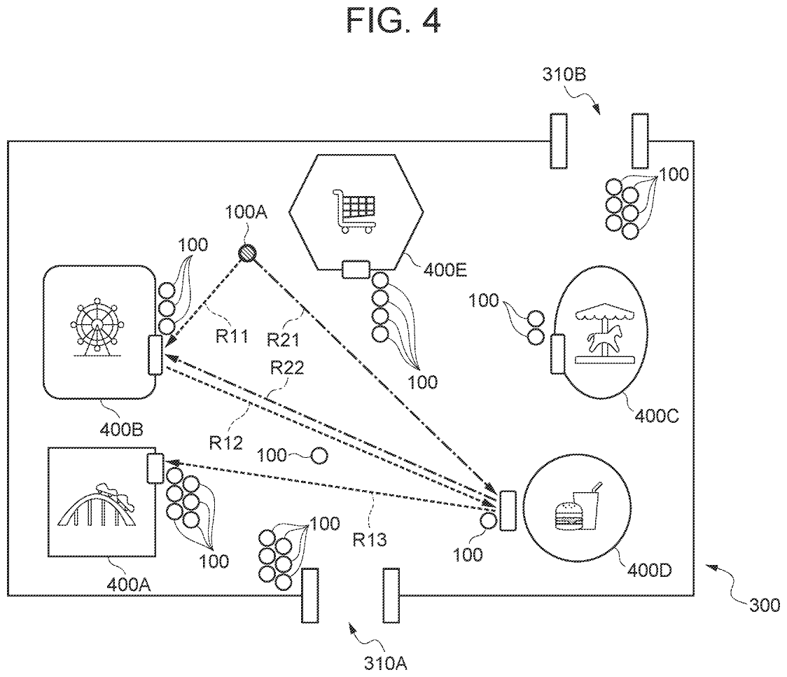

FIG. 4 schematically shows an amusement park as an example of the outdoor facility 300 where the mobile objects 100 are used. The outdoor facility 300 includes a plurality of attractions 400A to 400C including a merry-go-round, a Ferris wheel, and a roller coaster, a restaurant 400D, and a shop 400E. Hereinafter, when specific attractions or the like are referred, they are designated as an attraction 400A, a restaurant 400D, or the like. When unspecific attractions or the like are referred, they are simply referred as the attractions or the like 400. The attractions or the like 400 may be other than buildings. They may be landmarks, such as meeting spots. The outdoor facility 300 includes a plurality of entrances 310A, 310B. The memory 130B in each of the mobile objects 100 stores map information including location information on the attractions or the like 400, and the entrances 310A, 310B. The mobile objects 100 can move to these attractions or the like 400 in accordance the operation of the users. The users may make the mobile objects 100 wait in the standby places provided in the vicinity of the attractions or the like 400. The users can get off the mobile objects 100, and receive prescribed services provided through the attractions or the like 400. The users may receive the services while riding in the mobile objects 100, depending on the attractions or the like 400. Irrespective of the operation of the users, the mobile objects 100 are configured not to go out through the entrances 310A, 310B. For example, there are 1000 mobile objects 100. For example, only specific visitors, who reserved to use the mobile objects 100 in advance, can use the mobile objects 100.

A process for a user to use the mobile object 100 will be described below. FIG. 5 is a flowchart for describing a method of using the mobile object 100 according to the embodiment. In the present embodiment, the user approaches any one mobile object 100A, out of the mobile objects 100 waiting in a chargeable station in the vicinity of the entrance 310A or 310B of the outdoor facility 300. The user places the two-dimensional barcode, on a ticket displayed on the personal digital assistant 210 possessed by the user, over the bar-code reader included in the communication unit 120 of the mobile object 100A. The two-dimensional barcode includes user's identification information. The mobile object 100A receives the user's identification information (step S501).

Next, the communication unit 120 of the mobile object 100A transmits to the server apparatus 200 the user's identification information received from the bar-code reader and identification information on the mobile object 100A recorded in advance on the memory 130B through, for example, the network N such as the wireless LAN, by using a wireless communication device such as the WiFi (step S502).

When receiving the user's identification information and the identification information on the mobile object 100A from the mobile object 100A (step S503), the server apparatus 200 authenticates whether the user identified by the received identification information is registered in the database as an authorized user of the mobile object 100A, with reference to a database included in the server apparatus 200 (step S504).

Here, when authentication is not successful, the server apparatus 200 notifies to the mobile object 100A that the user is not authorized as a user of the mobile object 100A (step S505).

When authentication is successful, the server apparatus 200 further acquires, from the database, information on the name of the user, or the like, and information such as event information of the day in the outdoor facility 300, and transmits the acquired information to the mobile object 100A (step S506). The server apparatus 200 further registers in the database that the prescribed user is using the mobile object 100A.

When receiving these pieces of information through the network N, the controller 130 of the mobile object 100A displays on the display unit 140 of the mobile object 100A the user's name or the like, and the event information received from the server apparatuses 200. The controller 130 further displays on the display of the display unit 140 the map information, or the like, on the outdoor facility 300 read from the memory 130B (step S507). Therefore, the user can easily check the event information of the day, or the locations of the attractions or the like 400 in the outdoor facility 300. The mobile object 100A also transits to a state of accepting operation by the user. Furthermore, the user can unlock the luggage compartment unit 105 using the operating unit 106, stores the user's luggage in the luggage compartment unit 105, and then lock the luggage compartment unit 105. After that, the user can start to move by driving the mobile object 100A. When the mobile object 100A transits to a usable state, the mobile object 100A transmits the current location information to the server apparatus 200 (step S508). The server apparatus 200 receives the current location information from the mobile object 100A and other mobile objects 100 (step S509). As described later, when the users of other mobile objects 100 determine specific attractions or the like 400 as future destinations, the server apparatus 200 also acquires the location information on the attractions or the like 400 as the future destinations of the pertinent mobile objects 100.

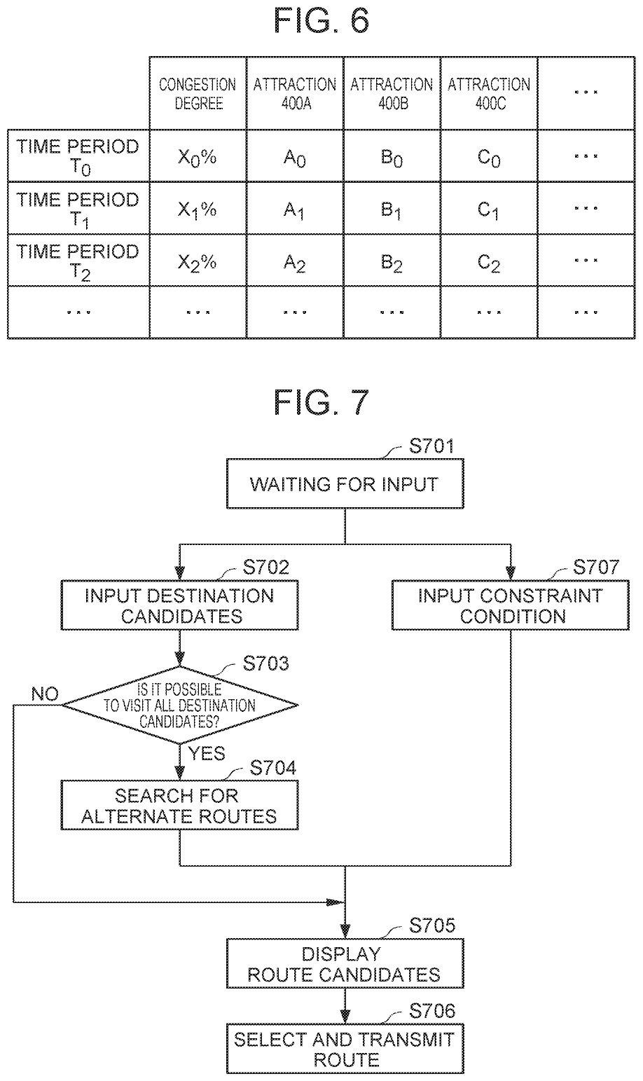

FIG. 6 shows an example of the location information on other mobile objects 100 acquired by the server apparatus 200. Since the server apparatus 200 receives the location information on the mobile object 100A in use and other mobile objects 100 together with the identification information on the mobile objects 100, the server apparatus 200 can acquire information indicating an average congestion degree of the outdoor facility 300 at current time, based on a ratio of the number of the mobile objects 100 in use to the number of all the available mobile objects 100. The server apparatus 200 may further acquire information on the congestion degree of the outdoor facility 300 with use of the information, such as the number of other visitors who do not use the mobile objects 100. The congestion degree may be acquired as a ratio to the total number of people that can be accommodated, may be indicated as a specific number of visitors, or the number of the mobile objects 100 in use, or may be information indicating the degree of the magnitude of visitors.

The server apparatus 200 also acquires information indicating the number of the mobile objects 100 waiting in the standby place provided in the vicinity of each of the attractions or the like 400, based on the current location information received from each of the other mobile objects 100. For example, as shown in FIG. 6, the server apparatus 200 can acquire information “A₀” as the information indicating the number of the mobile objects 100 present in the attraction 400A in the time period T₀. Instead of the number of the mobile objects, the server apparatus 200 may acquire information indicating the time converted into waiting time, and the degree of the magnitude of the congestion degree. The number of other mobile objects 100 may be corrected in consideration of the information on the number of visitors who do not use the mobile objects 100, and the server apparatus 200 may acquire the corrected value as information indirectly indicating the locations of other mobile objects 100.

The server apparatus 200 can further acquire the location information on other mobile objects 100 in future time. For example, as described later, in the case where the user of the mobile object 100B determines a schedule of using the attraction 400C in a future time period Tₘ, and using the attraction 400B in a future time period Tₙ, the server apparatus 200 can acquire the information that the mobile object 100B is present in the attraction 400C in the time period Tₘ, and present in the attraction 400B in the time period Tₙ. When such information is acquired from all the mobile objects 100, it is possible to acquire the location information on other mobile objects 100 in future time. For example, FIG. 6 shows that the number of other mobile objects 100 present in the attraction 400A is A₁ in a time period T₁, and the number of other mobile objects 100 present in the attraction 400A shifts to A₂ in a time period T₂. The server apparatus may further acquire information directly or indirectly indicating the amount of other mobile objects 100 present in each of the attractions or the like 400 in future time by machine learning based on weather, the total number of visitors, an actual number of other mobile objects 100 present in each of the attractions or the like 400 in the past, and actual waiting time in each of the attractions or the like 400. For example, such information may be acquired at intervals of 15 minutes from open to close of the facility.

The server apparatus 200 transmits, to all the mobile objects 100 including the mobile object 100A, all mobile object location information regarding current and future locations of all the mobile objects 100, the location information on which the server apparatus 200 can acquire (step S510). The server apparatus 200 does not acquire the future location information regarding the mobile objects 100 which do not yet determine their routes. The mobile object 100A receives the all mobile object location information from the server apparatus 200 (step S511). The all mobile object location information includes the current location information on the mobile object 100A and other mobile object location information regarding other mobile objects 100, the location information on which is acquired by the server apparatus 200. Since the mobile object 100A already has the current location information on the mobile object 100A itself, the mobile object 100A may be configured not to acquire the information from the server apparatus 200. The mobile object 100 may display on the display an image indicating the congestion situation in each of the attractions or the like 400 in the outdoor facility 300 based on the received information.

Each of the steps from step S508 for acquiring current location information on the mobile object 100A itself and transmitting the received information to the server apparatus 200 to step S511 for receiving current and future location information on other mobile objects described above is periodically executed. Accordingly, even in the case where other mobile objects 100 change their originally scheduled routes to move due to such reason as cancel of a prescribed attraction or bad weather, the mobile object 100A can acquire information reflecting such change.

FIG. 7 is a flowchart showing destination setting procedures performed by the user. The mobile object 100A is in the state of awaiting destination setting input by the user (step S701).

The user can select and input a desired destination candidate or candidates by pressing one or more attractions or the like 400 out of the attractions or the like 400 displayed on the display unit 140 of the mobile object 100A (step S702). The user may also input a constraint condition (a condition that the user wishes to be satisfied without fail). The examples of the constraint condition include: a condition that use of all the attractions 400 or the like be completed by given time; a condition for starting to dine at the restaurant 400D at prescribed time; a condition for using a prescribed attraction or the like 400 without fail; a condition that the attractions or the like 400 be enjoyable for small children; or a condition that waiting time be a prescribed time or less.

In FIG. 4, in the case where the user of the mobile object 100A, who is present in a middle point between the attraction 400B and the shop 400E, inputs the attractions 400B, 400C and the restaurant 400D as destination candidates, the controller 130 can calculate a route R11 for moving from the current location to the attraction 400B, and a moving time thereof, based on the map information on the outdoor facility 300 including the location information on the mobile object 100A and location information on the mobile objects 100 in the nearby attraction 400B. The controller 130 can also acquire the waiting time in the attraction 400B that is converted from the number of other mobile objects 100 present in the attraction 400B at the time point when the mobile object 100 arrives at the attraction 400B. The controller 130 can further acquire an average service provision time (time for riding in the Ferris wheel) in the attraction 400B recorded in advance on the memory 130B. Therefore, the controller 130 can recognize a scheduled time of departing the attraction 400B by adding up the time for the user to arrive at the attraction 400B from the current location, waiting time in the attraction 400B, and also the time until the service provision in the attraction 400B is completed. Similarly, the controller 130 can calculate a route R12 from the attraction 400B to the restaurant 400D and a moving time thereof. The controller 130 can also acquire, through calculation, waiting time until the user enters the restaurant 400D, based on the number of other mobile objects 100 present in the restaurant 400D in a time period when the user is scheduled to arrive at the restaurant 400D. The controller 130 can further acquire an average service provision time (mealtime) in the restaurant 400D recorded in advance on the memory 130B.

Based on the calculation as described above, the controller 130 can determine the possibility of receiving the service provided in all the destination candidates input by the user (step S703). For example, in the case where it is hard to visit all the destination candidates by the time the outdoor facility 300 is closed while satisfying the constraint condition because too many destination candidates are selected, the controller 130 determines that it is difficult to visit all the destination candidates input by the user. There is also a case where it is difficult to satisfy the wishes of the user as the waiting time of a popular attraction or the like 400 is a bottleneck.

In such a case, the controller 130 searches for one or more alternate routes which enable the user to visit as many destination candidates as possible, out of the destination candidates input by the user (step S704). For example, the controller 130 can present to the user a route of directly moving from the current location to the restaurant 400D as in the route R21 (FIG. 4) so as to use the restaurant when it is not busy instead of in the time period when the restaurant 400D is most congested, and then moving from the restaurant 400D to the attraction 400B as in the route R22. When it is predicted that a long time is required for visiting the attraction 400A, the controller 130 can search for a route excluding the attraction 400A, though the attraction 400A is input as one of the destination candidates, and presents the route to the user. It is also possible to search for a route which is not necessarily a shortest route of connecting between the attractions, like a route from the route R21 to the route R22, and to present the route to the user. The controller 130 displays one or more alternate routes on the display of the display unit 140. With the displayed alternate routes, the attractions 400 or the like that the user is scheduled to visit are displayed together with visit time periods (step S705).

When the user selects one of the presented alternate routes using the touch panel, or the like, of the operating unit 106, the controller 130 of the mobile object 100A records the selected route information on the memory 130B and transmits the information to the server apparatus 200 (step S706). Therefore, the server apparatus 200 can acquire location information on the mobile object 100A in future time. Similarly, the server apparatus 200 acquires location information in future time from other mobile objects 100 in a similar manner. The server apparatus 200 may be configured such that when the user selects a route including the prescribed attractions or the like 400, use of the attractions or the like 400 by the user of the mobile object 100A may be reserved. For example, in the case where the user of the mobile object 100A selects a route of using the attraction 400C in the future time period Tₘ, and using the attraction 400B in the time period Tₙ, the server apparatus 200 may be configured to transmit to the communication device included in each of the attraction 400C or the like, notification that the user of the mobile object 100A uses the attraction 400C in the time period Tₘ, and the user of the mobile object 100A uses the attraction 400B in the time period Tₙ, so as to provide the service through the attraction 400C or the like without waiting time, when the user of the mobile object 100A visits there in the time period Tₘ or the like. Such configuration can eliminate the necessity of the user of the mobile object 100A to wait for a long time around the attraction 400C or the like, after getting off the mobile object 100A. The controller 130 of the mobile object 100A may be configured to guide or autonomously drive along a route which is not a shortest route, in order to arrive at the attraction 400C in the time period Tₘ. The controller 130 of the mobile object 100A may be configured such that when it is possible to determine, based on the current location information on the mobile object 100A, that the mobile object 100A is moving along a route clearly different from the selected route, reservation of the attraction 400C or the like by the user of the mobile object 100A is cancelled after confirmation by the user.

Once the route is selected, the user can move along the selected route by driving the mobile object 100. The mobile object 100 displays guidance information for guiding the selected route on the display unit 140. The mobile object 100 may travel autonomously in accordance with the selected route. Here, the map information on the outdoor facility 300 recorded on the memory 130B includes information for identifying regions where the mobile object 100A can travel, and regions where the mobile object 100A cannot move, such as stair regions, off-road regions, and steep hill regions. The controller 130 can determine the route to the attractions or the like 400 so as to travel within a movable region.

The user does not necessarily need to input the destination candidates. For example, the user may input a restraint condition, such as the waiting time being a prescribed time or less, or other conditions (step S707), and the controller 130 may be configured to search for a route candidate which satisfies the input constraint condition (step S705). In such a case, the controller 130 can also search for a route which can satisfy the constraint condition and which enables the user to enjoy a large number of attractions or the like, based on current and future location information on other mobile objects 100.

Using the aforementioned mobile objects facilitate movement in a huge outdoor facility, and also makes it easy to visit a plurality of attractions, or the like, located in an area too far to try to visit before. Since the route can be selected based on current and future location information on other mobile objects, congestion of the entire outdoor facility can be eased. The vehicle body is provided with a roof unit for shading sunlight, and further, cold air, or the like, can be supplied to the users from the air conditioner of the air conditioning unit. This makes it possible to provide a comfortable space for the users even in the outdoor environment.

The mobile objects can also be used in other facilities, such as safari parks and zoos, other than the amusement parks. The mobile objects may also be configured to output the information regarding nearby attractions, or the like, from the display or the speaker of the mobile objects, based on the current location information on the mobile objects. For example, in the safari parks and zoos, video images and voices of animals living in the vicinity of the current location may be output.

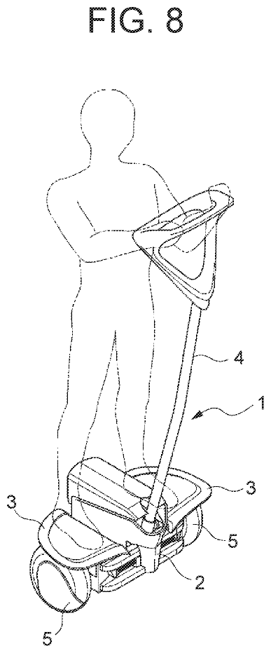

FIG. 8 is a perspective view showing a schematic configuration of an inverted mobile object 1 according to a modification. The present disclosure may be applied to the mobile object 1 as shown in FIG. 8. The mobile object 100 and the mobile object 1 may be used in union.

For example, the inverted mobile object 1 includes a vehicle body 2, a pair of right and left step portions 3 attached to the vehicle body 2 for allowing a user to ride on, an operating handle 4 tiltably attached to the vehicle body 2 for allowing the user to grasp, and a pair of right and left driving wheels 5 rotatably attached to the vehicle body 2. For example, the inverted mobile object 1 is configured as a coaxial two-wheeler having the driving wheels 5 coaxially arranged and traveling while keeping an inverted state. The inverted mobile object 1 is configured to move forward and backward when the user moves his or her center of gravity forward and backward, and inclines each of the step portions 3 of the vehicle body 2 forward and backward. The inverted mobile object 1 is configured to turn right or left when the user moves his or her center of gravity rightward or leftward, and inclines the step portions 3 of the vehicle body 2 rightward or leftward. The vehicle body 2 has a luggage compartment unit provided below the step portions 3 for storing and keeping the luggage of the user, such as a suitcase. In order to expand the accommodation space of the luggage compartment unit, the step portions 3 may be provided at a position further higher than illustrated. Above the operating handle 4, a display device such as a display may further be provided.

Such a mobile object 1 may be implemented with a wheel driving unit including an electric motor for driving the driving wheels 5, an attitude sensor for detecting the attitude of the vehicle body 2, a pair of rotation sensors for detecting rotation information on the respective driving wheels 5, a controller for controlling each of the wheel driving units, and a battery for supplying electric power to the wheel driving unit and the controller.

The mobile object 1 can also facilitate movement in a huge outdoor facility, and makes it possible to visit facilities, such as attractions, located in an area too far to try to visit before.

Leader-follower relationship may be provided to a group of the mobile objects 1. For example, the mobile objects 1 may be configured such that when a leader mobile object 1 transmits a group command, or when the time set by the leader mobile object comes, follower mobile objects 1 come close to the leader mobile object 1 irrespective of the operation by the users. Such configuration makes it possible to use the mobile objects 1 without worrying about injuries or getting lost, in the case where the mobile objects 1 are used for group tourists, excursions, factory tours, families, and the like.

Various deformations of the present disclosure are possible without departing from the scope of the disclosure. For example, some component members of a certain embodiment may be added to other embodiments within the range of general creativity of a person skilled in the art. Some component members in a certain embodiment may also be replaced with the corresponding component members in other embodiments.

What is claimed is:

1. A mobile object for moving within a facility, comprising:
a candidate location information acquisition device configured to acquire candidate location information regarding locations of a plurality of destination candidates in the facility;
a current location information acquisition device configured to acquire current location information on the mobile object;
an other mobile object information acquisition device configured to acquire other mobile object location information regarding locations of a plurality of other mobile objects that move within the facility; and
a route acquisition device configured to acquire a route for moving to at least one destination candidate out of the destination candidates, based on the candidate location information, the current location information, and the other mobile object location information.

2. The mobile object according to claim 1, further comprising a display device configured to display the route acquired by the route acquisition device to a user of the mobile object.

3. The mobile object according to claim 1, wherein the other mobile object location information includes information regarding locations of the other mobile objects in future time.

4. A mobile object for moving within a facility, comprising:
an input unit configured to receive inputs of at least two destination candidates, out of a plurality of destination candidates in the facility, from a user of the mobile object;
a candidate location information acquisition device configured to acquire candidate location information regarding locations of the destination candidates input via the input unit;
a current location information acquisition device configured to acquire current location information on the mobile object;
an other mobile object information acquisition device configured to acquire other mobile object location information regarding locations of other mobile objects that move within the facility; and
a route acquisition device configured to acquire a route for moving from the current location to at least two destination candidates, selected out of the destination candidates input via the input unit, based on the candidate location information, the current location information, and the other mobile object location information.

5. The mobile object according to claim 1, wherein the other mobile object location information includes information indicating the number of the other mobile objects scheduled to be present in each of the at least two destination candidates in each of a plurality of time periods.

6. A server apparatus for a moving system using a plurality of mobile objects that move within facility, the server apparatus comprising:
a current location information acquisition device configured to acquire current location information from each of the mobile objects;
a schedule information acquisition device configured to acquire from each of the mobile objects schedule information indicating a schedule to be in a prescribed destination candidate in a prescribed time period; and
an output device configured to output, to one of the mobile objects, information indicating the number of the other mobile objects scheduled to be present in the prescribed destination candidate in the prescribed time period.
